(19) United States
(12) Patent Application Publication
(10) Pub. No.: US 2026/0318366 A1
(43) Pub. Date: Oct. 15, 2026

(54) AIRCRAFT PROPULSION ASSEMBLY COMPRISING A PROPULSION POWER TRANSMISSION SYSTEM WITH THE CAPACITY TO DECOUPLE TWO ROTATING ELEMENTS ACTUATED FROM THE INSIDE OF ONE OF THE ROTATING ELEMENTS

(71) Applicant: SAFRAN HELICOPTER ENGINES, BORDES (FR)

(72) Inventors: Loïs Pierre Denis VIVE, MOISSY-CRAMAYEL (FR); Lucie Stéphanie APOSTIN, MOISSY-CRAMAYEL (FR); Christian Omer Henri SARRAT, MOISSY-CRAMAYEL (FR); Samuel Christian JOUSSELIN, MOISSY-CRAMAYEL (FR)

(21) Appl. No.: 19/484,946

(22) PCT Filed: May 22, 2024
(86) PCT No.: PCT/FR2024/050661

§ 371 Date: Nov. 17, 2025

(30) Foreign Application Priority Data
May 26, 2023 (FR) FR2305270

(51) Int. Cl. B64D 35/025; F16D 27/118

(52) U.S. Cl. CPC F16D 11/10; B64D 27/33; B64D 35/025; F02C 7/36; F16D 11/14; F16D 25/083; F16D 27/118; F16D 2011/004

(57) ABSTRACT

A system for the transmission of propulsion power of a propulsion assembly for an aircraft comprises for coupling a first rotating element with a second rotating element, and an actuator for moving the second rotating element axially between a coupling position in which the coupling are engaged with one another, and a disengaging position in which the coupling are disengaged from one another. The actuator comprises an actuating member extending in a bore of the second rotating element and cooperating with a drive device. A rolling bearing is interposed between the actuating member and an inner surface of the second rotating element so as to secure the actuating member and the second rotating element to one another axially while allowing the second rotating element to rotate freely relative to the actuating member. The first rotating element is kinematically connected to the rotor of an electric machine configured to receive propulsion power from the first rotating element

### TECHNICAL FIELD

The present invention relates to the field of aircraft propulsion assemblies and relates more particularly to a transmission system with the capacity to decouple two rotating elements.

Such transmission systems aim in particular to enable efficient torque transmission between a turbomachine and an electric machine, while enabling decoupling between them in the event of failure, or to prevent failure of the electric motor, or of equipment, components or systems in relation thereto, without requiring the complete shutdown of the turbomachine.

The main propulsion engines of aircraft generally drive non-propulsive electrical power generation machines, at a moderate speed, typically in the order of a few thousand revolutions per minute. These electric machines are sometimes prone to failures, particularly of mechanical origin, with relatively high prevalence rates compared to the reliability required for the main motors. One way to continue using the propulsion engine is then to mechanically disconnect the electric machine from the turbomachine.

With the development of hybrid thermal/electric propulsion systems, it is desirable to develop reliable, lightweight, inexpensive and easily integrable mechanical decoupling systems, which are also adapted to the specificities of such systems.

Indeed, in propulsion assemblies comprising a turbogenerator intended to generate propulsive electrical energy, the electric machines have a power of an order of magnitude comparable to the power of the turbomachine (this nevertheless depends on the number of electric machines driven by the turbomachine), while the non-propulsion electric machine of a conventional propulsion assembly is relatively “small” compared to the thermal motor.

In addition, the mechanical power received by an electric machine within such a propulsion assembly is considerably greater than that received by a non-propulsion electric machine of a conventional propulsion assembly.

Furthermore, the mass of such a machine is not negligible compared to that of the complete propulsion system, which results in a strong interest in optimizing this mass by using high-speed electric machines (in the order of several tens of thousands of revolutions per minute) and/or by using permanent magnet machines, also called “PMG” for “Permanent Magnet Generators”, which have a high power mass density, but for which short-circuit cases cannot be treated simply by de-energizing the rotor.

Furthermore, transmission systems with the capacity to decouple also find application within “parallel” hybrid propulsion assemblies, where power can be selectively supplied by a thermal motor and/or by an electric motor to a receiver such as a propeller. When it is sought to use reversible electric machines, in particular to be able to carry out functions such as recharging power batteries, it is then worthwhile or even necessary to also have decoupling mechanisms between the electric motor-generator and the receiver.

Climate change is a major concern for many legislative and regulatory bodies around the world. Indeed, various restrictions on carbon emissions have been, are, or will be adopted by various states. In particular, an ambitious standard applies not only to new types of aircraft but also to those currently in circulation requiring the implementation of technological solutions in order to make them compliant with the regulations in force. Civil aviation has been taking action for several years now to make a contribution to the fight against climate change.

Technological research efforts have already made it possible to significantly improve the environmental performance of aircraft. All of the players in the sector are continuously working to improve energy efficiency. The Applicant considers the factors impacting in all design and development phases to obtain aeronautical components and products that are less energy-consuming, more environmentally friendly and of which the integration and use in civil aviation have moderate environmental impacts with the aim of improving the energy efficiency of air transport.

Consequently, the Applicant is continuously working to reduce its negative climate impact through the use of methods and the operation of virtuous development and manufacturing methods and minimizing greenhouse gas emissions to as little as possible to reduce the environmental footprint of its activity.

This sustained research and development work covers both the new generations of aircraft engines, the reduction of the weight of aircraft, in particular through the materials used and lighter on-board equipment, the development of the use of electrical technologies to ensure propulsion, and, indispensable complements to technological progress, aviation biofuels.

To this end, the invention is the result of technological research aimed at very significantly improving aircraft performance and, accordingly, helps reduce their environmental impact.

### PRIOR ART

A wide variety of disengageable coupling devices between two rotating elements, generally shafts, are known. These devices essentially consist of:
ramp devices, wherein an actuator acts radially on a ramp secured to one of the rotating elements so as to cause an axial movement of the rotating element causing decoupling between the latter and the other rotating element;
screw devices, which operate according to a principle similar to the previous one, the ramp being replaced by a thread and the actuator being shaped to act on the thread and cause the axial movement of the rotating element in the manner of a screw-nut effect;
ball devices, wherein the connection between the rotating elements is made by means of balls capable of being disengaged from their housing to carry out the decoupling;
freewheel devices that can be disengaged on command;
devices with an actuated frangible section, wherein the rupture of a section is caused by contact with a friction member controlled for this purpose;
devices with a frangible section by thermal fusion; and
axial piston devices, wherein a piston is axially displaced to cause one of the rotating elements to mechanically decouple from the other rotating element.

The implementation of ramp and screw devices presents a risk of jerks which may limit their ability to operate at high speed, and these devices generally present a risk of premature wear. In addition, the radial size of the actuator of such devices is sometimes unacceptable.

Ball devices are generally characterized by irreversible operation, prohibiting any possibility of rearming.

Frangible section devices are destructive and may damage nearby components. In addition, these devices cannot be tested.

Document EP3746669A1 provides an example of a device of the latter type, i.e. with an axial piston, wherein an annular hydraulic actuator is arranged around an intermediate pinion itself axially interposed between two shafts to be connected. The hydraulic actuator is configured to axially move the intermediate pinion so as to mechanically decouple the latter from one of the shafts, under the effect of fluid pressure.

However, such a device proves to be bulky and costly due to a relatively large number of moving parts involved in its operation.

Thus, there is a need for transmission systems with the capacity to decouple that are of limited mass and size.

There is also a need for transmission systems with the capacity to decouple that are adapted as far as possible to the coupling of rotating elements intended for the transmission of propulsion power (typically having to transmit power levels in the order of several hundred of kilowatts) and/or rotating elements at high speeds (typically in the order of several tens of thousands of revolutions per minute), and/or which are adapted to power transmission in both directions of rotation. The latter property is used in particular in the case of electric machines for generating propulsion power, which also serve as starters for turbomachines.

Finally, there is a need for transmission systems with the capacity to decouple having a reversible mode of operation allowing them to be rearmed.

### DISCLOSURE OF THE INVENTION

The invention aims to remedy these needs at least partially.

For this purpose, it proposes a transmission system with the capacity to decouple for an aircraft propulsion assembly, comprising:
a first rotating element;
a second rotating element mounted in rotation along an axis relative to a stator;
coupling means configured to mechanically couple the first rotating element with the second rotating element when said coupling means are engaged, and to be disengaged under the effect of a movement of the second rotating element along the axis; and
an actuator for axially moving the second rotating element, on command, between a coupling position wherein the coupling means are engaged, and a disengagement position wherein the coupling means are disengaged; wherein:
the actuator comprises an actuating member extending at least partially into a bore of the second rotating element and cooperating with a drive device configured to axially move the actuating member;
a rolling bearing is interposed between the actuating member and an inner surface of the second rotating element so as to axially secure the actuating member and the second rotating element while allowing a free rotation of the second rotating element relative to the actuating member.

The invention thus provides a transmission system with the capacity to decouple, offering advantages in terms of space and mass limitation, and adapted to the applications mentioned above.

In some embodiments, the actuator is an electromechanical actuator.

Thus, the actuator can advantageously be a linear solenoid actuator.

In other embodiments, the actuator is a single-acting or double-acting cylinder.

In some embodiments, the actuating member includes a channel for circulating a lubricant fluid up to the bore of the second rotating element.

In such embodiments, the second rotating element advantageously comprises ports connecting its bore with at least one lubrication chamber formed on an outer surface of the second rotating element.

In some embodiments, the transmission system comprises a spring which axially stresses the actuating member in a direction from the disengagement position to the coupling position.

In some embodiments, the first rotating element is a shaft, and the second rotating element is a coupling sleeve or a coupling pinion, coaxial to the shaft.

The invention also relates to an aircraft propulsion assembly, comprising a receiver, an electric machine, a turbomachine and a transmission system of the type described above, wherein the first rotating element of the transmission system is kinematically connected to a rotor of the electric machine while the second rotating element of the transmission system is kinematically connected to a rotor of the turbomachine, and wherein at least one of the electric machine and the turbomachine is configured to transmit a propulsion power to the receiver.

In some embodiments, the first rotating element is a shaft, the second rotating element is a coupling sleeve coupled to a coupling pinion so as to be rotatably secured to the latter but such that the coupling sleeve is free to move axially relative to the coupling pinion, and wherein the coupling sleeve is kinematically connected to the rotor of the turbomachine via the coupling pinion.

In some embodiments, the electric machine is configured to receive propulsion power from the first rotating element.

### BRIEF DESCRIPTION OF THE DRAWINGS

The invention will be better understood, and further details, advantages and characteristics thereof will appear on reading the following description given by way of non-limiting example and with reference to the appended drawings wherein:

FIG. 1 is a schematic axial cross-sectional view of an aircraft propulsion assembly comprising an electric machine, a turbomachine and a transmission system with the capacity to decouple;

FIG. 2 is a schematic axial cross-sectional view of a transmission system with the capacity to decouple according to a first embodiment of the invention which may form part of the propulsion assembly of FIG. 1, shown in a coupling configuration;

FIG. 3 is a view similar to FIG. 2, wherein the transmission system is shown in a decoupling configuration;

FIG. 4 is a view similar to FIG. 2, illustrating a transmission system with the capacity to decouple according to a second embodiment of the invention, which may also form part of the propulsion assembly of FIG. 1;

FIG. 5 is a view similar to FIG. 4, wherein the transmission system is shown in a decoupling configuration;

FIG. 6 is a view similar to FIG. 4, illustrating a variant of the second embodiment;

FIG. 7 is a view similar to FIG. 4, illustrating another variant of the second embodiment;

FIG. 8 is a view similar to FIG. 2, illustrating a transmission system with the capacity to decouple according to a third embodiment of the invention, which may also form part of the propulsion assembly of FIG. 1, shown in a decoupling configuration.

In all of these figures, identical references may designate identical or similar elements.

### DETAILED DISCLOSURE OF PREFERRED EMBODIMENTS

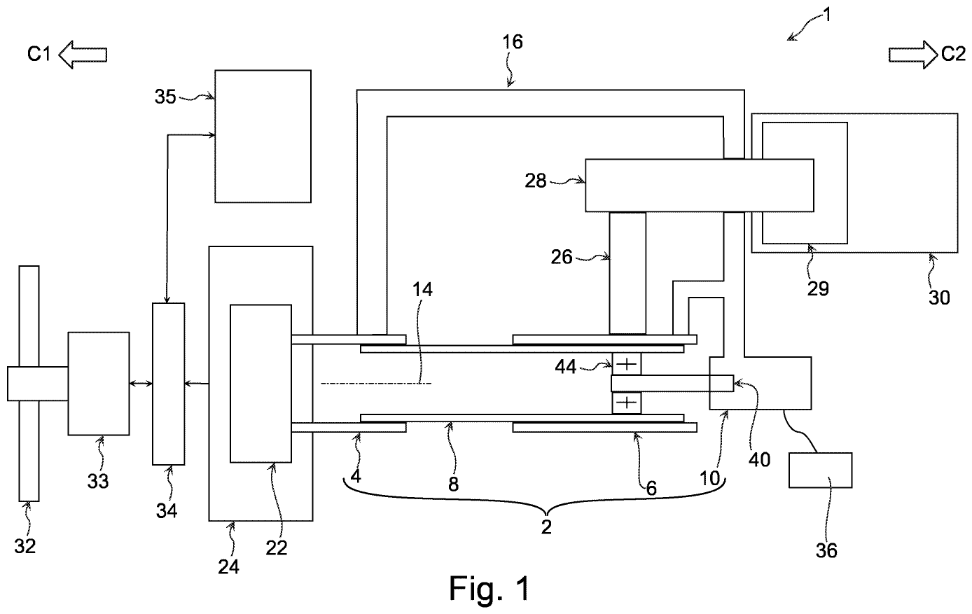

FIG. 1 very schematically illustrates an aircraft propulsion assembly 1, comprising a transmission system 2 with the capacity to decouple according to a first embodiment of the invention.

This transmission system 2 generally comprises a shaft 4, a coupling pinion 6, a coupling sleeve 8, and an actuator 10.

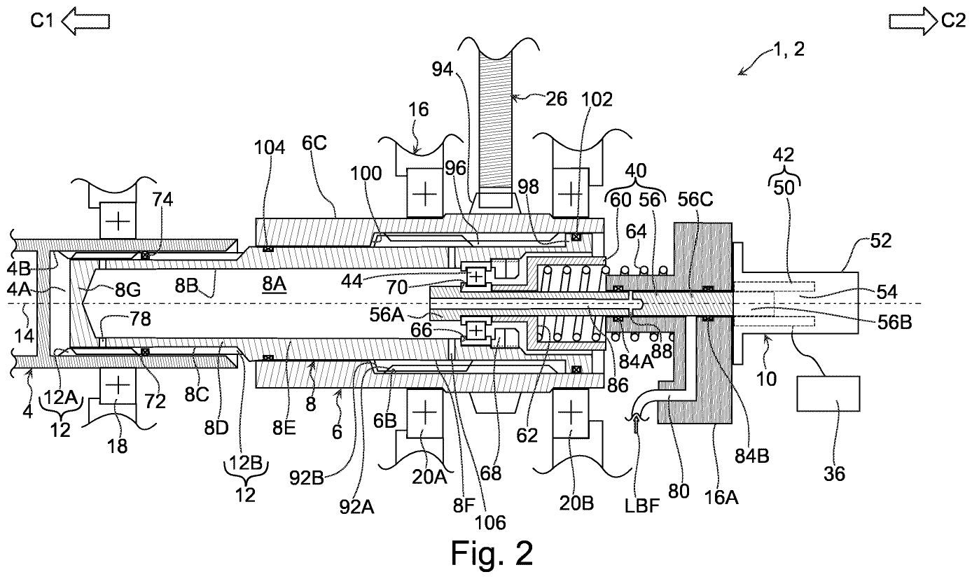

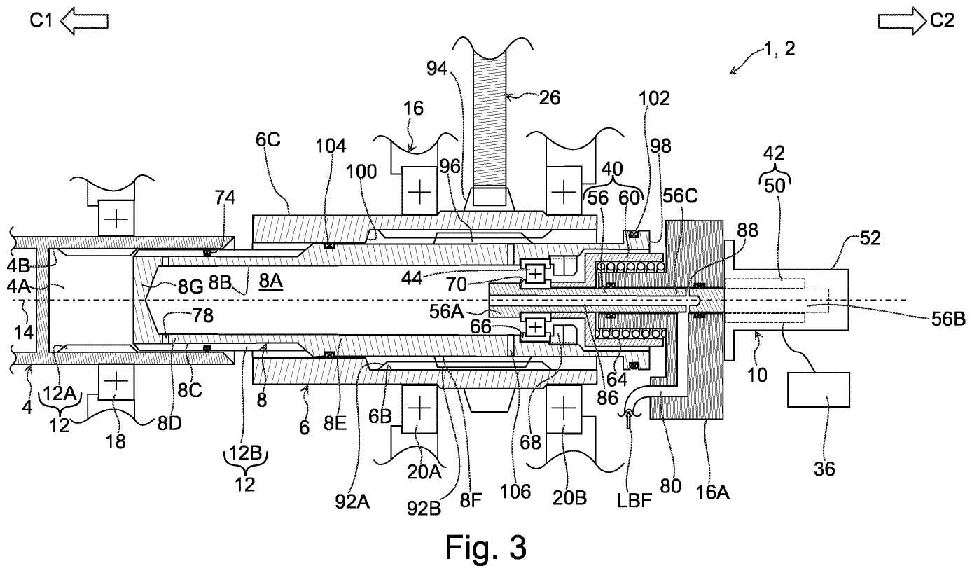

The transmission system 2, seen in more detail in FIGS. 2 and 3, is configured to allow a disengageable coupling between the shaft 4 and the coupling pinion 6 by means of the coupling sleeve 8. For this purpose, disengageable coupling means 12 are provided for mechanically coupling the shaft 4 with the coupling sleeve 8, as will appear more clearly hereinafter.

The shaft 4 is mounted in rotation relative to a stator 16, for example by means of one or more guide bearings 18 (one of which can be seen in FIGS. 2-6), on a first side C1 of the transmission system. The coupling pinion 6 is mounted in rotation along an axis 14 relative to the stator 16, typically by means of one or more—for example two—guide bearings 20A, 20B, on a second side C2 of the transmission system. The coupling sleeve 8 is mounted in the coupling pinion 6, or, alternatively, on the latter, so as to be secured in rotation to the latter and to have an axial sliding ability relative to the latter, as will appear more clearly hereinafter. The axis 14 therefore also forms an axis of rotation for the coupling sleeve 8. Furthermore, the axis 14 advantageously forms the axis of rotation of the shaft 4. The axis 14 defines an “axial” direction according to the terminology used in the present description.

The shaft 4 is an example of a first rotating element, while the coupling sleeve 8 is an example of a second rotating element, according to the terminology used in the most general definition of the invention.

In some embodiments, the shaft 4, or more generally the first rotating element, is kinematically connected to an electric machine rotor, and the coupling sleeve 8, or more generally the second rotating element, is kinematically connected to a turbomachine rotor. By “kinematically connected” elements, it should be understood generally in the context of the present description that the elements in question are secured in rotation or form a gear (i.e. are engaged with one another), or form a gear train by being mechanically connected via one or more pinions.

In the example illustrated, the shaft 4 is for example secured to the rotor 22 of an electric machine 24 (FIG. 1), while the coupling pinion 6 is engaged with an idler pinion 26 (visible in full in FIG. 1 and partially visible in FIGS. 2-8), the latter also being engaged with a rotor 28 of a turbine 29 of a turbomachine 30 (FIG. 1). The idler pinion 26 thus ensures a transmission of rotational movement between the coupling pinion 6 and the rotor 28 of the turbine 29. In view of the above, it will be understood that the shaft 4 may, in other examples, be directly or indirectly mechanically engaged with the rotor 22 of the electric machine 24, i.e. form a gear or a gear train with the latter.

Furthermore, the propulsion assembly 1 illustrated further comprises a receiver 32, such as a propeller or a fan, the drive of which relies on energy supplied by at least one of the electric machine 24 or the turbomachine 30 (if applicable, by the rotor 28 of the turbine 29), to ensure the propulsion of an aircraft. The energy supplied by the electric machine 24 may be electrical or mechanical energy, depending on the type of architecture of the propulsion assembly and depending on the role played by the electric machine within this propulsion assembly.

The transmission system 2 is in particular intended to form part of a mechanical propulsion transmission system within an aircraft hybrid propulsion assembly.

The propulsion assembly 1 is for example a series hybrid propulsion assembly, wherein the receiver 32 is mechanically engaged with an electric motor 33 supplied with electrical energy by a distribution unit 34, itself supplied with electrical energy in parallel by a power battery 35, on the one hand, and by the electric machine 24, on the other hand. The latter is thus configured to operate as a generator of propulsive electrical energy by converting mechanical energy received from the turbomachine 30 and supplying the resulting electrical energy to the distribution unit 34. The latter typically comprises DC/AC and AC/DC conversion means. Thus, the distribution unit 34 also makes it possible to recharge the power battery 35 with excess electrical power in certain operating phases. In such a case, a transmission system with the capacity to decouple similar to the transmission system 2, which will be described in detail hereinafter, can, alternatively or additionally, ensure a disengageable mechanical coupling between a shaft of the receiver 32 and the rotor of the electric motor 33.

In other examples, the propulsion assembly 1 may be of the parallel hybrid type, i.e. comprising a transmission system, for example of the type comprising a gear train reducer, configured to mechanically couple the electric machine to the receiver, operating selectively as a motor or generator, and the turbomachine, in parallel. In this case, the electric machine is supplied with electrical energy by a power battery when it operates as a motor and recharges said battery when it operates as a generator driven by the turbomachine, via the mechanical transmission system.

In order to allow a disengageable coupling between the shaft 4 and the coupling sleeve 8 and thus indirectly allow a disengageable coupling between the shaft 4 and the coupling pinion 6, the coupling means 12 are configured to couple the shaft 4 with the coupling sleeve 8 when these coupling means 12 are engaged, and to be disengaged under the effect of a movement of the coupling sleeve 8 along the axis 14.

The actuator 10 is configured to axially move the coupling sleeve 8, on command, between a coupling position, for example located on the first side C1, wherein the coupling means 12 are engaged, and a disengagement position, for example located on the second side C2, wherein the coupling means 12 are disengaged. The control of the actuator 10 is for example triggered by a control unit 36 receiving signals representative of the state of the propulsion assembly from one or more sensors provided for this purpose.

To allow axial movement of the coupling sleeve 8, the actuator 10 generally comprises an actuating member 40, of which at least a portion extends into a bore 8A of the coupling sleeve 8 from an end of the latter, for example located on the second side C2, or more generally on the side opposite the side where the coupling means 12 are arranged.

This actuating member 40 cooperates with a drive device 42 configured to axially move the actuating member 40, if necessary under the effect of a command received for this purpose from said control unit 36.

Furthermore, a rolling bearing 44 is interposed between said portion of the actuating member 40 and an inner surface 8B of the coupling sleeve 8 so as to axially secure the actuating member 40 and the coupling sleeve 8 while allowing a free rotation of the coupling sleeve 8 relative to the actuating member 40.

Different exemplary configurations of the actuator 10 and the coupling means 12 will be described hereinafter through the disclosure of several embodiments of the invention.

In the first embodiment illustrated in FIGS. 2 and 3, wherein the coupling sleeve 8 is respectively in the coupling position and in the disengagement position, the actuator 10 is an electromechanical actuator, in particular a linear solenoid actuator. It should be understood thereby that the drive device 42 of the actuator comprises a solenoid 50 electrically controlled by the control unit 36, and that this solenoid 50 is fixedly housed in a housing 52 secured to a stator structure 16A (forming part of the stator 16) and that it delimits a central space 54 within which an end portion 56B of an actuating rod 56 extends. This actuating rod 56 is a portion of the actuating member 40.

The end portion 56B of the rod 56 is thus the portion of the actuating member 40 which cooperates with the drive device 42. In addition, an end portion 56A of the rod 56, on the opposite side, is the portion of the actuating member 40 in contact with or cooperating with the rolling bearing 44, as will appear more clearly hereinafter. The stator structure 16A, arranged axially between the housing 52 and the coupling sleeve 8, includes for example a through passage through which a medial portion 56C of the actuating rod 56 extends.

The actuating member 40 further includes a support sleeve 60 secured in translation to the actuating rod 56 and forming a seat 62 for an end of a preload spring 64, of which the opposite end bears against the stator structure 16A, such that the preload spring 64 axially stresses the actuating rod 56 in the direction of the first side C1. The support sleeve 60 may be integral with the actuating rod 56 or, as in the example illustrated, be mounted thereon.

The rolling bearing 44 is for example held axially in position relative to the coupling sleeve 8 by being sandwiched between a shoulder 66 formed in the bore 8A of the coupling sleeve 8, on the first side C1 relative to the bearing 44, and a nut 68 screwed into an internal thread formed on the inner surface 8B of the coupling sleeve 8, on the second side C2 relative to the bearing 44.

Similarly, the rolling bearing 44 is for example held axially in position relative to the actuating rod 56 by being sandwiched between a shoulder 70 of the rod 56, located on the first side C1, and the support sleeve 60, located on the second side C2, relative to the bearing 44.

The positioning of the rolling bearing 44 may thus comprise bringing the bearing 44 to its final position around the actuating rod 56 in the bore 8A from the opening of the latter located on the second side C2, then screwing the nut 68 into the coupling sleeve 8 until a suitable tightening of an outer ring of the bearing 44 against the shoulder 66 is obtained, and finally the positioning of the support sleeve 60 around the actuating rod 56 such that the latter is able to hold an inner ring of the bearing 44 against the shoulder 70.

Moreover, in the example illustrated in FIGS. 2 and 3, the coupling means 12 comprise first coupling splines 12A extending radially inward from an inner surface 4B delimiting a bore 4A of the shaft 4, and second coupling splines 12B extending radially outward from an outer surface 8C of a first portion 8D of the coupling sleeve 8 for example located on the first side C1. The first and second coupling splines 12A, 12B have conjugated configurations to allow securing in rotation of the coupling sleeve 8 and the shaft 4.

In the coupling position (FIG. 2), the first portion 8D of the coupling sleeve 8 is engaged in the bore 4A of the shaft 4 such that the first coupling splines 12A are engaged with the second coupling splines 12B and the shaft 4 and the coupling sleeve 8 are thus secured in rotation.

In the disengaged position (FIG. 3), the coupling sleeve 8 is axially offset toward the second side C2, relative to the coupling position, such that the first coupling splines 12A are not engaged with the second coupling splines 12B and that the shaft 4 and the coupling sleeve 8 are free to rotate relative to each other.

In the example illustrated, the shaft 4 and the first portion 8A of the coupling sleeve 8 are configured to define between them a first lubrication chamber 72 intended to allow the lubrication of the first coupling means 12, in the coupled position (FIG. 2).

The tightness of the first lubrication chamber 72 is for example ensured by means of a compressible annular seal 74 housed in a corresponding groove, arranged at a location located axially on the second side C2 relative to the first splines 12A in the coupling position (FIG. 2), and formed in the coupling sleeve 8 (or alternatively in the shaft 4), such that the seal 74 is compressed between the shaft 4 and the coupling sleeve 8.

The first lubrication chamber 72 communicates with the bore 8A of the coupling sleeve 8, for example via first through holes 78 formed through the coupling sleeve 8, to allow the supply of the first lubrication chamber 72 with a lubricating fluid, such as oil, from the bore 8A. For this purpose, the bore 8A is for example closed on the first side C1 by an end wall 8G of the coupling sleeve 8, and on the second side C2, by the bearing 44 and the actuating member 40. In addition, the bore 8A is in turn supplied with lubricant fluid by a supply device provided for this purpose. This device comprises for example in particular a duct 80 formed in the stator structure 16A and having an inlet intended to be supplied with lubricant fluid LBF, and an outlet leading to the through passage delimited by the stator structure 16A, more specifically in an annular chamber 82 arranged around the actuating rod 56 and defined axially between two compressible annular seals 84A, 84B. The supply device further comprises a channel 86 formed in the actuating rod 56, for example at the center thereof, and one or more orifices 88 formed in the actuating rod 56 so as to connect the channel 86 with said annular chamber 82, regardless of the axial position of the rod 56, from the position corresponding to the coupling position of the coupling sleeve 8 to the position corresponding to the disengagement position of the coupling sleeve 8. The channel 86 leads to the bore 8A of the coupling sleeve 8 via a free end of the end portion 56B of the actuating rod 56, whereby the channel 86 makes it possible to inject the lubricant fluid LBF from the duct 80 into the bore 8A.

Moreover, in the example illustrated, the coupling pinion 6 (or at least a portion thereof) is arranged around a second portion 8E of the coupling sleeve 8, located on the second side C2 relative to the first portion 8D of the latter. To allow the coupling pinion 6 to be secured in rotation to the coupling sleeve 8, but the coupling sleeve 8 to be free to move axially relative to the coupling pinion 6, the coupling pinion 6 is for example provided with internal splines 92A formed on an inner surface 6B of the latter and engaged with external splines 92B formed on an outer surface 8F of the second portion 8E of the coupling sleeve 8. These splines 92A, 92B are sized to remain engaged regardless of the axial position of the coupling sleeve 8 from its coupling position to its disengagement position. In addition, the coupling pinion 6 is for example provided, on its outer surface 6C, with external teeth 94 engaged with the idler pinion 26.

The second portion 8E of the coupling sleeve 8 and the coupling pinion 6 are for example configured to define a second lubrication chamber 96 between them, intended to ensure lubrication of the splines 92A, 92B.

For this purpose, the coupling sleeve 8 includes for example a structure 98, such as a flange, protruding outward from the outer surface 8F of the second portion 8E of the coupling sleeve 8, so as to come to a short distance from the inner surface 6B of the coupling pinion 6, beyond the splines 92A, 92B in the direction of the second side C2. In addition, the coupling pinion 6 includes for example a structure 100, such as a shoulder protruding inward from the inner surface 6B of this pinion, so as to come to a short distance from the outer surface 8F of the sleeve, beyond the splines 92A, 92B in the direction of the first side C1. The structures 98 and 100 thus axially delimit the second lubrication chamber 96 between them.

The tightness of the second lubrication chamber 96 is for example ensured by means of compressible annular seals 102 and 104 respectively compressed between the flange 98 and the coupling pinion 6, and between the outer surface 8F of the coupling sleeve 8 and the coupling pinion 6 in a location located beyond the shoulder 100 in the direction of the first side C1.

The second lubrication chamber 96 communicates with the bore 8A of the coupling sleeve 8, for example via second through holes 106 formed through the coupling sleeve 8, to allow the supply of the second lubrication chamber 96 with lubricant fluid, from the bore 8A.

In operation, the coupling sleeve 8 being initially in the coupling position (FIG. 2), the lubricant fluid LBF injected by the channel 86 into the bore 8A supplies the two lubrication chambers 72 and 96.

Moreover, the preload spring 64 axially stresses the actuating rod 56 in the direction of the first side C1 and thus helps hold the coupling sleeve 8 in the coupling position.

When a decoupling of the shaft 4 and the coupling pinion 6 is required, the control unit 36 induces the solenoid 50 to move the actuating rod 56 in the direction of the second side C2 by driving the coupling sleeve 8 with it to the disengaged position, such that the coupling splines 12A, 12B are no longer engaged with each other. The coupling sleeve 8 is thus decoupled from the shaft 4, whereby the shaft 4 and the coupling pinion 6 are decoupled.

In some embodiments, synchronization means (not described here) allow the shaft 4 and the coupling sleeve 8 to be brought into unison and angular coincidence in order to allow their recoupling. To implement such a recoupling, the control unit 36 then induces the solenoid 50 to move the actuating rod 56 in the direction of the first side C1 by driving the coupling sleeve 8 with it to the coupling position, such that the coupling splines 12A, 12B are engaged with each other. The coupling sleeve 8 is thus recoupled to the shaft 4, whereby the shaft 4 and the coupling pinion 6 are recoupled.

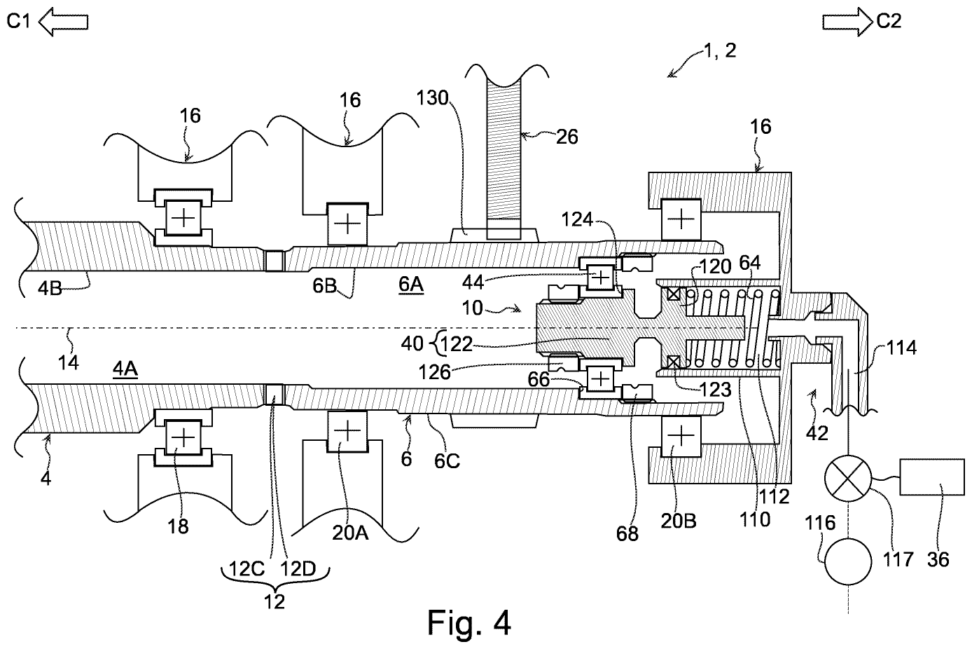

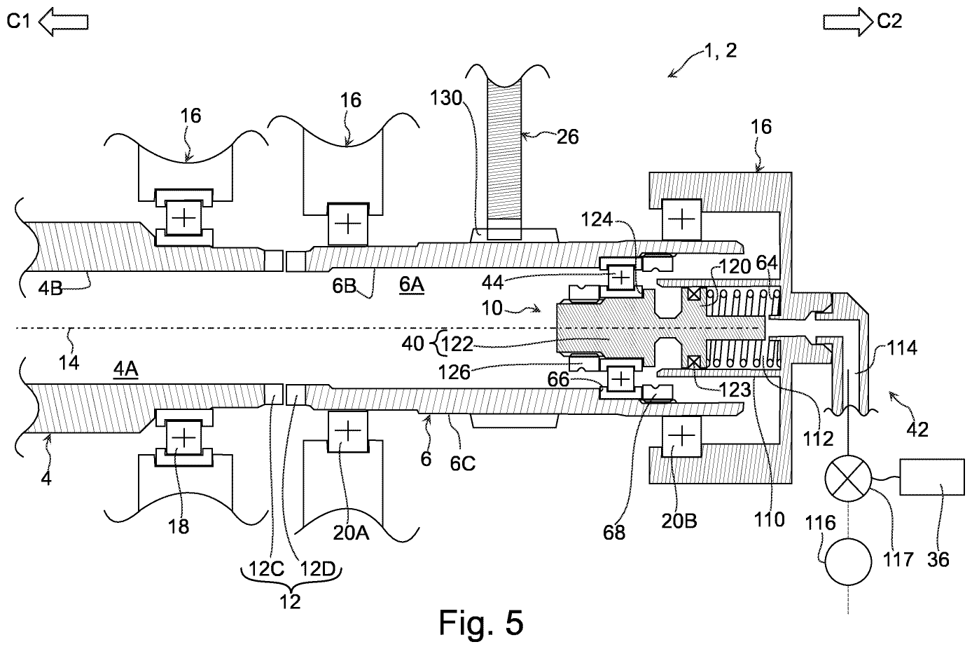

FIGS. 4 and 5 illustrate a second embodiment of the invention, wherein there is no coupling sleeve, the role of second rotating element, according to the most general definition of the invention, being played here by the coupling pinion 6.

Incidentally, the actuator 10 in this second embodiment is a single-acting hydraulic or pneumatic cylinder.

In addition, the coupling means 12 are dog clutches 12C, 12D formed respectively on the shaft 4 and on the coupling pinion 6.

More specifically, the actuator 10 includes a cylinder body 110 secured to the stator 16 and delimiting a cylinder chamber 112 to which a duct 114 adapted for fluid circulation leads. This duct is for example connected to a pump 116 capable of generating a negative pressure of the fluid in the duct 114, and therefore, in the cylinder chamber 112. The pump 116, and/or a valve 117 provided on the duct 114, is operationally connected to the control unit 36 to be controlled by the latter and thus allow control of the actuator 10.

On the first side C1, or more generally on the side of the coupling position, the cylinder chamber 112 is delimited by an axially movable piston 120 rigidly connected to an actuating rod 122 extending beyond the piston 120 in the direction of the first side C1 up into the bore 6A of the coupling pinion 6. The piston 120 is for example provided, on its periphery, with a compressible seal 123 in contact with the inner surface of the cylinder body 110 to ensure the tightness of the cylinder chamber 112.

The actuating rod 122 is connected to the coupling pinion 6 by the rolling bearing 44, in a manner similar to that described above in relation to the first embodiment. In the terminology of the invention, the actuating rod 122 is an example of an actuating member 40 of the actuator 10, while the cylinder body 110, the piston 120, the duct 114 and the pump 116 form an example of a drive device 42 of the actuator 10.

A spring 64 is furthermore compressed between the piston 120 and a bottom of the cylinder chamber 112 so as to stress the piston 120, and therefore the actuating rod 122, in the direction of the first side C1.

The rolling bearing 44 is for example held axially in position relative to the coupling pinion 6 in a manner similar to that described above in relation to the first embodiment.

In addition, the rolling bearing 44 is for example held axially in position relative to the actuating rod 122 by being sandwiched between a shoulder 124 of the rod 122, located on the second side C2 relative to the bearing 44, and a nut 126, located on the first side C1 relative to the bearing 44. The rod 122 may thus be assembled with the bearing 44 by inserting the rod 122 through the inner ring of the bearing 44, in the direction of the first side C1, then by mounting the nut 126 on the rod from the first side C1.

The coupling pinion 6 further comprises external teeth 130 formed on the outer surface 6C of the latter and whereby this coupling pinion is engaged with the idler pinion 26. These external teeth 130 and the corresponding teeth of the idler pinion 26 are straight teeth such that the relative axial movement between the coupling pinion 6 and the idler pinion 26 is possible without inducing significant axial force on these elements. In addition, the external teeth 130 have an axial range such that the coupling pinion 6 remains engaged with the idler pinion 26 regardless of the axial position of the coupling pinion 6, from the coupling position (FIG. 4) to the disengagement position (FIG. 5).

At its end located on the second side C2, the shaft 4 includes the dog clutches 12C which, in the coupled configuration of FIG. 4, are engaged with the dog clutches 12D formed at the end of the coupling pinion 6 located on the first side C1.

In operation, the spring 64 tends to hold the coupling pinion 6 in the coupling position (FIG. 4).

A decoupling of the shaft 4 and the coupling pinion 6 is implemented by generating a negative pressure in the cylinder chamber 112 by means of the pump 116, to such an extent that the resulting force exceeds that induced by the spring 64, so as to move the actuating rod 122 in the direction of the second side C2. Thus, the rod drives the coupling pinion 6 with it up to the disengaged position, such that the dog clutches 12C, 12D are no longer engaged with each other. The shaft 4 and the coupling pinion 6 are thus decoupled.

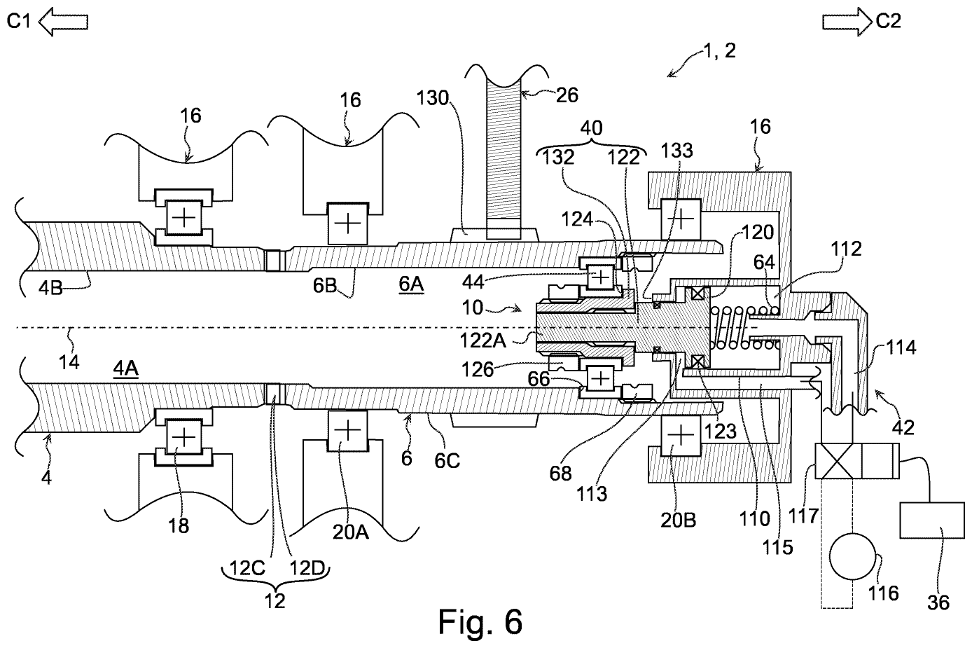

FIG. 6 illustrates a variant, similar to the embodiment of FIGS. 4 and 5, but wherein the actuator 10 is a double-acting hydraulic or pneumatic cylinder.

Thus, the cylinder body 110 delimits two cylinder chambers 112 and 113 to which ducts 114 and 115 configured to be selectively supplied with fluid under pressure lead, and thus selectively increase the pressure in one or the other of the cylinder chambers 112 and 113 and thus cause the movement of the actuating rod 122 in the direction of the first side C1 or the second side C2.

For this purpose, the ducts 114 and 115 are for example connected, via a suitable nozzle 117, to a circuit wherein the circulation of a pressurized fluid, for example a lubricant, is driven by means of a pump 116. Thus, the pump 116 is not necessarily specifically assigned to controlling the cylinder but may be the pump of a lubrication circuit of the turbomachine.

In this case, the spring 64 fulfills a preload function, i.e. it helps hold the coupling pinion 6 in the coupling position, particularly when the fluid pressure in the chamber 112 alone is insufficient to achieve this. This is particularly advantageous at low speed in embodiments where the power of the pump 116 depends on the operating speed of the turbomachine.

The duct 114 and the pump 116 form for example part of a lubrication circuit of the turbomachine, in which case the fluid in question is a lubricant fluid such as oil.

Incidentally, in the example illustrated in FIG. 6, the actuating member 40 is provided with a nut 132 mounted on the end 122A of the actuating rod 122 located on the first side C1 and on which the rolling bearing 44 is mounted in a manner similar to that described above. In this case, this configuration of the actuating member 40 makes it possible to facilitate the assembly of the assembly composed of the actuator 10, the coupling pinion 6 and the rolling bearing 44.

Moreover, the cylinder body 110 has for example an end forming a stop 133 against an end of the nut 132 and thus limiting the travel of the actuating member 40 toward the second side C2, and thus defining the disengagement position.

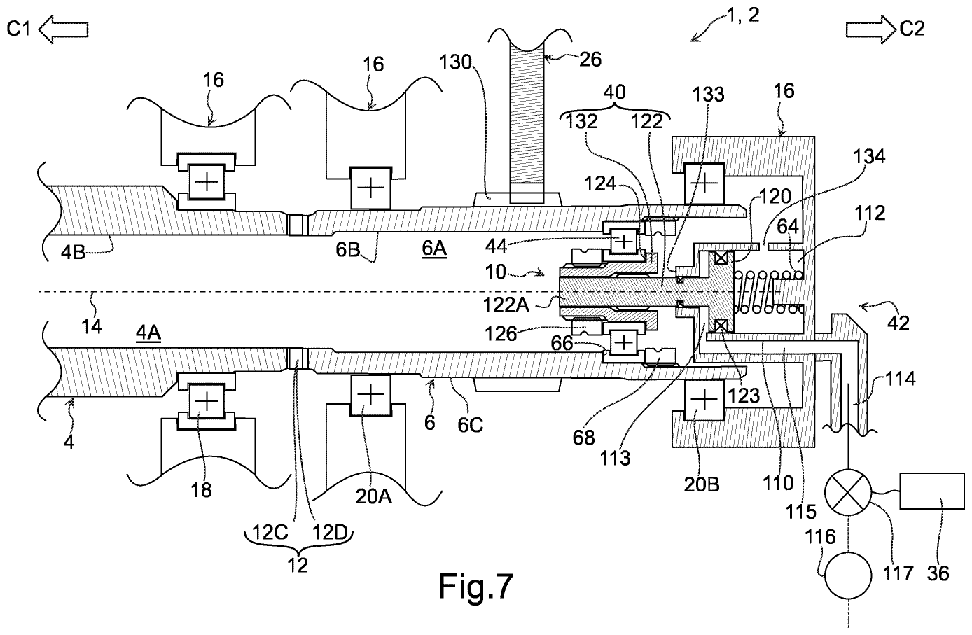

FIG. 7 illustrates another variant wherein the actuator 10 is still a single-acting hydraulic or pneumatic cylinder, but configured so that a pressure of the fluid in its chamber 113 acts against the force induced by the spring 64.

For this purpose, the single chamber 113 receiving fluid is for example defined on the other side of the piston 120 relative to the chamber 112 housing the spring 64, the latter still operating as a compression spring. The chamber is not connected to a fluid supply but is provided with a vent 134. In addition, the pump 116 is here configured to supply the chamber 113 with pressurized fluid. Thus, the spring 64 still tends here to hold the coupling pinion 6 in the coupling position, while an injection of pressurized fluid into the chamber 113 makes it possible, when the force applied by the fluid to the piston 120 exceeds that induced by the spring 64, to move the actuating rod 122 in the direction of the second side C2, in a manner similar to that explained above in relation to FIG. 6. The injection of pressurized fluid into the chamber 113 may be performed by the pump 116 and/or by opening a valve 117 provided on the duct 114 in order to make the duct 114 communicate with a pressurized fluid circuit, such as a lubrication circuit of the turbomachine, as explained above.

Of course, other embodiments are still possible without leaving the scope of the invention.

For example, dog clutch type coupling means, such as those of FIGS. 4 and 5, may be used in the embodiment of FIGS. 2 and 3 instead of the coupling splines 12A, 12B.

Moreover, the coupling sleeve 8 or the coupling pinion 6 may be formed of sections connected by ball-and-socket-effect hinge means, for example convex splines, so as to increase a permissible degree of misalignment between the shaft 4 and the actuating member 40.

Moreover, the coupling means 12 may, in other embodiments, be arranged to ensure a disengageable coupling between the coupling pinion 6 and the idler pinion 26. In other words, according to the terminology used in the most general definition of the invention, the role of first rotating element is then played by the idler pinion 26, while the role of second rotating element is played by the coupling pinion 6.

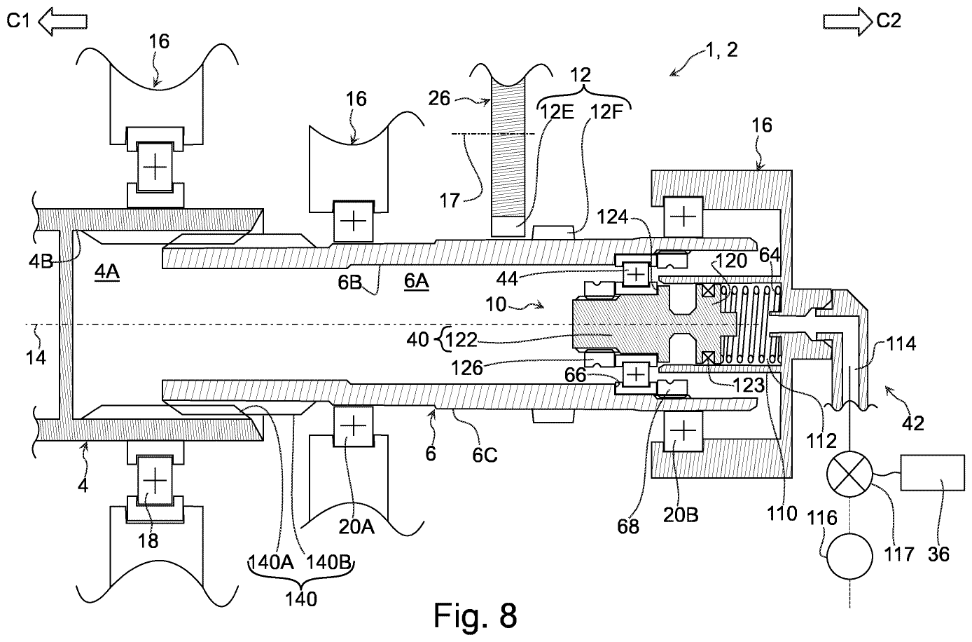

FIG. 8 illustrates an example of such an embodiment, wherein the coupling means 12 consist of external teeth 12E of the coupling pinion 6 and teeth 12F of the idler pinion 26, arranged to be engaged when the coupling pinion 6 is in a coupling position, and to be disengaged when the coupling pinion 6 is in a disengagement position (as illustrated in FIG. 8).

The coupling between the shaft 4 and the coupling pinion 6 is, in such cases, ensured by coupling means 140, such as straight splines 140A, 140B, configured to remain engaged regardless of the position of the coupling pinion 6. A relative axial movement between the coupling pinion 6 and the shaft 4 is thus made possible without inducing significant axial force on these elements.

In the example illustrated, the first rotating element (in this case the idler pinion 26) is arranged offset relative to the axis 14. More specifically, the idler pinion 26 is mounted in rotation along an axis 17 separate from the axis 14. In the example illustrated, the axis 17 of the idler pinion 26 is parallel to the axis 14 of the shaft 4 and the coupling pinion 6. Alternatively, the axis 17 of the idler pinion and the axis 14 of the coupling pinion may be secant, by means of a suitable configuration of the coupling means 12.

The example of FIG. 8 shows a single-acting cylinder-type actuator similar to that of FIGS. 4 and 5, but such embodiments are of course compatible with other types of actuators, particularly with the electromechanical actuator of FIGS. 2 and 3 or with a cylinder such as those of FIGS. 6 and 7.

In addition, analogous arrangements to those described above in relation to FIGS. 1 and 2 may be provided for lubricating the coupling means 140, this being possible regardless of whether the actuator is similar to the electromechanical actuator of FIGS. 2 and 3 or whether it is a cylinder as in FIGS. 4-7.

What is claimed is:

1. An aircraft propulsion assembly comprising:
a receiver;
an electric machine;
a turbomachine; and
a propulsion power transmission system, with the capacity to decouple;
wherein at least one of the electric machine and the turbomachine is configured to transmit a propulsion power to the receiver;
wherein the transmission system comprises:
a first rotating element kinematically connected to a rotor of the electric machine, the electric machine being configured to receive a propulsive power from the first rotating element;
a second rotating element mounted in rotation along an axis relative to a stator and kinematically connected to a rotor of the turbomachine;
coupling means configured to mechanically couple the first rotating element with the second rotating element when said coupling means are engaged, and to be disengaged under the effect of a movement of the second rotating element along the axis; and
an actuator for axially moving the second rotating element, on command, between a coupling position wherein the coupling means are engaged, and a disengagement position wherein the coupling means are disengaged;
wherein:
the actuator comprises an actuating member extending at least partially into a bore of the second rotating element and cooperating with a drive device configured to axially move the actuating member;
a rolling bearing is interposed between the actuating member and an inner surface of the second rotating member so as to axially secure the actuating member and the second rotating member while allowing a free rotation of the second rotating member relative to the actuating member.

2. The aircraft propulsion assembly according to claim 1, wherein the actuator is an electromechanical actuator.

3. The aircraft propulsion assembly according to claim 2, wherein the actuator is a linear solenoid actuator.

4. The aircraft propulsion assembly according to claim 1, wherein the actuator is a single-acting or double-acting cylinder.

5. The aircraft propulsion assembly according to claim 1, wherein the actuating member includes a channel for circulating a lubricant fluid up to the bore of the second rotating element.

6. The aircraft propulsion assembly according to claim 5, wherein the second rotating element comprises ports connecting the bore of the latter with at least one lubrication chamber formed on an outer surface of the second rotating element.

7. The aircraft propulsion assembly according to claim 1, comprising a spring which axially stresses the actuating member in a direction from the disengagement position to the coupling position.

8. The aircraft propulsion assembly according to claim 1, wherein the first rotating element is a shaft and the second rotating element is a coupling sleeve or a coupling pinion coaxial to the shaft.

9. The aircraft propulsion assembly according to claim 1, wherein the first rotating element is a shaft, the second rotating element is a coupling sleeve coupled to a coupling pinion so as to be secured in rotation to the latter but such that the coupling sleeve is free to move axially relative to the coupling pinion and wherein the coupling sleeve is kinematically connected to the rotor of the turbomachine via the coupling pinion.
